(19) United States
(12) Patent Application Publication
(10) Pub. No.: US 2026/0078597 A1
(43) Pub. Date: Mar. 19, 2026

(54) Double-Impeller Leaf Collector

(71) Applicant: Cixi Hengsheng Swimming Pool Supplies Co., Ltd, Zhejiang (CN)

(72) Inventor: Hangrui LIN, Zhejiang (CN)

(73) Assignee: Cixi Hengsheng Swimming Pool Supplies Co., Ltd, Zhejiang (CN)

(21) Appl. No.: 18/885,595

(22) Filed: Sep. 14, 2024

(51) Int. Cl. E04H 4/16; B01D 29/11; C02F 1/00; C02F 103/42; F04D 13/02; F04D 29/18; F04D 29/52; F04D 29/70

(52) U.S. Cl. CPC E04H 4/1636; B01D 29/11; C02F 1/001; F04D 13/02; F04D 29/185; F04D 29/528; F04D 29/708; C02F 2103/42

(57) ABSTRACT

A double-impeller leaf collector comprises a machine body, wherein the machine body is provided with a flow channel and a water absorption mechanism, the flow channel at least has a water inlet end and a water outlet end, and the water outlet end is provided with a garbage collection device; the water absorption mechanism comprises a driving device, and a lower impeller component and an upper impeller component arranged in the flow channel; wherein the driving device is connected with the lower impeller component and the upper impeller component through a transmission structure.

### TECHNICAL FIELD

The present disclosure relates to the technical field of swimming pool cleaning devices, in particular to a double-impeller leaf collector.

### BACKGROUND

Swimming pool suction device, also known as swimming pool suction device or underwater suction device, is a device specially used to clean the bottom or water surface of swimming pool. This kind of equipment can effectively remove the dirt such as hair and leaves in the pool water and keep the water clear and transparent.

The existing U.S. patent No. 20210164252 discloses a “SUCTION HEAD WITH CENTRAL DEFLECTOR FOR CLEANING SWIMMING POOLS” . The patent only has one impeller, and the suction force is small. At the same time, the high-speed rotation of a single impeller will lead to the vortex in the large-diameter sewage suction cavity to form turbulence. Moreover, the motor of this patent is arranged in the flow channel, which will block the flow of water, thus affecting the flow of the flow channel and causing too small suction.

Therefore, there is a need to put forward a new type of swimming pool sewage absorber, which has greater suction, the motor will not block the water flow, and it is not likely to produce vortex turbulence.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides a double-impeller leaf collector to solve the problems that the suction force is small, vortex turbulence will be produced and motor will block water flow in the existing swimming pool sewage suction device mentioned in the background technology.

In order to achieve the above purpose, the present disclosure provides a double-impeller leaf collector, which includes a machine body, wherein the machine body is provided with a flow channel and a water absorption mechanism; the flow channel is at least provided with a water inlet end and a water outlet end, and the water outlet end is provided with a garbage collection device; the water absorption mechanism includes a driving device, and a lower impeller component and an upper impeller component arranged in the flow channel; the driving device is connected with the lower impeller component and the upper impeller component through a transmission structure; the driving device drives the lower impeller component and the upper impeller component to rotate through the transmission structure, and drives the water to be sucked into the flow channel and then enter the garbage collection device for filtering.

The present disclosure further provides a double-impeller leaf collector, which includes a machine body, wherein the machine body is provided with a flow channel and a water absorption mechanism; the flow channel at least has a water inlet end and a water outlet end, and the water absorption mechanism includes a driving device and an impeller component installed in the flow channel; at least two groups of impeller components are arranged and close to the water inlet end and the water outlet end respectively, and the at least two groups of impeller components push water in the flow channel to form an axial flow; the driving device is accommodated in the machine body, and a transmission structure is arranged between the driving device and the impeller components.

The present disclosure further provides a double-impeller leaf collector, which includes a machine body, wherein the machine body is provided with a flow channel and a water absorption mechanism; the flow channel at least has a water inlet end and a water outlet end, and the water absorption mechanism includes a driving device, and a lower impeller component and an upper impeller component installed in the flow channel; the lower impeller component and the upper impeller component are respectively close to the water inlet end and the water outlet end, and the lower impeller component and the upper impeller component are used for pushing water in the flow channel to form an axial flow; the driving device is accommodated in the machine body, and a bevel gear transmission mechanism is arranged between the driving device and the lower impeller component and the upper impeller component.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a three-dimensional structural diagram of the present disclosure.

FIG. 2 is a schematic view of the three-dimensional structure of the present disclosure from another angle.

FIG. 3 is a bottom view of the present disclosure.

FIG. 4 is a cross-sectional view of section A-A in FIG. 2 of the present disclosure.

FIG. 5 is a partially enlarged view of area b in FIG. 3.

FIG. 6 is a structural schematic diagram of the driving device, transmission structure and impeller component of the present disclosure.

Reference signs: Machine body (1); Flow channel (101); Shell (11); Power supply module (111); Drive control board (112); Protective casing (12); Bearing (13); Chassis (14); Roller (141); Cleaning brush (142); Hinge part (15); Connecting handle (16); Driving motor (2); Output shaft (20); Driving bevel gear (21); Lower impeller component (3); First blade (30); First connecting rod (31); First driven bevel gear (32); Upper impeller component (4); Second blade (40); Second connecting rod (41); Second driven bevel gear (42); Garbage collection device (5).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

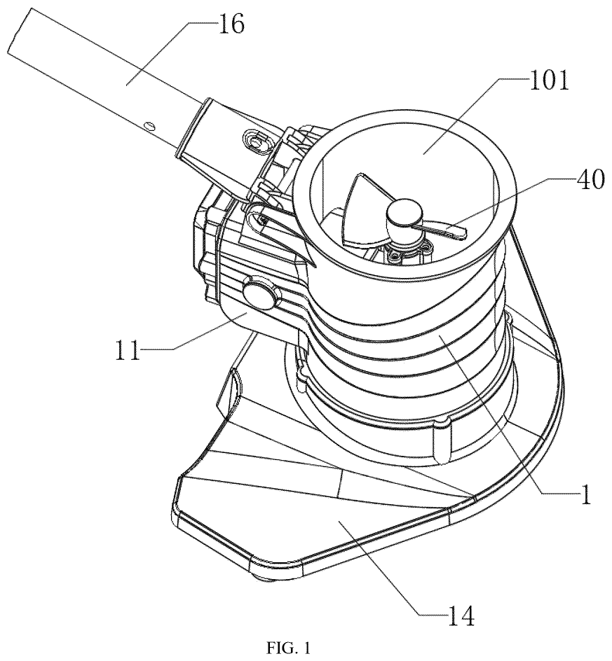

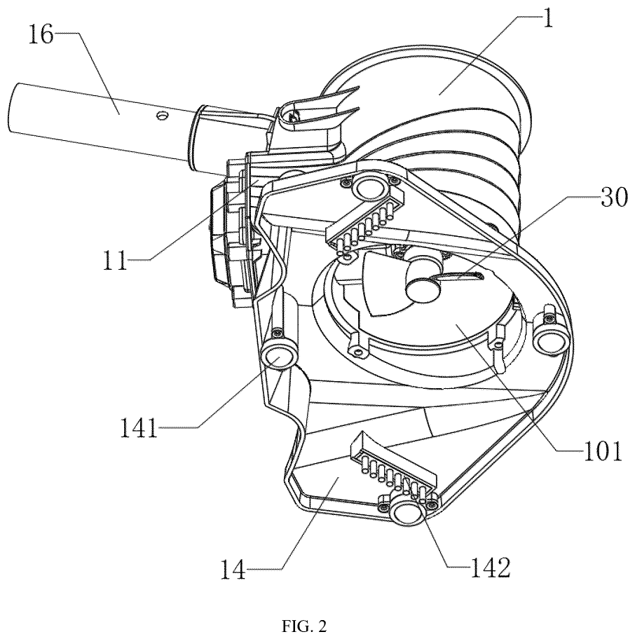

The present disclosure provides a double-impeller leaf collector, as shown in FIGS. 1-4, which includes a water absorption mechanism and a machine body 1 provided with a flow channel 101. The flow channel 101 has at least one water inlet end and one water outlet end, and the water outlet end of the flow channel 101 is provided with a garbage collection device 5.

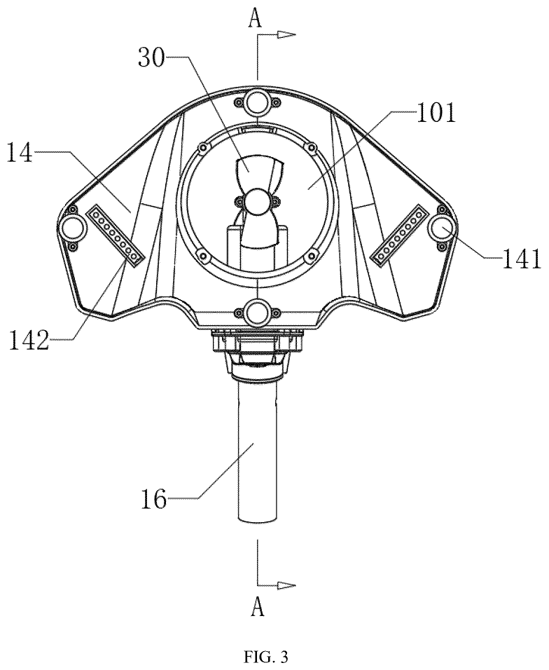

In this embodiment, as shown in FIG. 3, the water inlet end is arranged at the bottom of the flow channel 101, and the water outlet end is arranged at the top of the flow channel 101. The garbage collection device 5 is an external filter screen cover and is installed on the water outlet end. By the form of a net cover, water can pass through the garbage collection device 5, and garbage such as leaves can be filtered and collected.

In this embodiment, the water absorption mechanism includes a driving device, and a lower impeller component 3 and an upper impeller component 4 arranged in the flow channel 101 from bottom to top. The driving device is in transmission connection with the lower impeller component 3 and the upper impeller component 4 through a transmission structure, and the driving device drives the lower impeller component 3 and the upper impeller component 4 to rotate through the transmission structure, and drives the water to be sucked into the flow channel 101 and then enter the garbage collection device 5 for filtration.

In other possible embodiments (not shown), the garbage collection device 5 can also be a flexible pipe, and the flexible pipe extends to the place where sewage is collected. Therefore, when collecting the dirt in the pool water, the lower impeller component 3 and the upper impeller component 4 rotate and discharge the extracted sewage into the flexible pipeline, and the flexible pipeline discharges the pool water with dirt such as leaves and hair to the sewage collection place. Therefore, in this way, not only the garbage in the pool water can be treated, but also the sewage generated during garbage cleaning can be collected and treated together.

In other embodiments (not shown), the machine body 1 can also be made of a light material with high buoyancy, so that the machine body 1 can float in water. Therefore, when the present disclosure is used, the machine body 1 is turned up and down, so that the water inlet end of the flow channel 101 can face the water surface, and the water inlet end simultaneously draws water from the water surface. In this way, floating garbage such as leaves and hair floating on the water surface can be sucked and collected.

In this embodiment, the driving device includes a shell 11 and a driving motor 2 sealed in the shell 11. The shell 11 is fixedly connected to the side wall of the machine body 1, and the shell 11 is fixedly connected with a protective casing 12. The transmission structure is sealed in the protective casing 12. The shell 11 and the protective casing 12 are used to ensure that the driving motor 2 and the transmission structure can be isolated from water, so as to prevent the driving motor 2 from being damaged by water and the transmission structure from being stuck when foreign objects enter. In addition, the driving motor 2 and the power supply module 111 are arranged in the shell 11 and located at the side of the machine body 1, so that the space of the flow channel 101 is larger, the water flow throughput per unit time can be improved, and the cleaning is more efficient.

In this embodiment, the lower impeller component 3 includes a first connecting rod 31, and the upper impeller component 4 includes a second connecting rod 41. Bearings 13 are correspondingly arranged between the first connecting rod 31 and the protective casing 12, between the second connecting rod 41 and the protective casing 12, and between the output shaft 20 of the driving motor 2 and the shell 11. The addition of the bearings 13 improves the rotational smoothness of the corresponding parts of the present disclosure, reduces the energy loss and reduces the noise during the operation of the present disclosure.

The shell 11 is internally provided with a power supply module 111 and a driving control board 112, and the power supply module 111 is electrically connected with the driving motor 2 through the driving control board 112. The power supply module 111 can provide driving power for the driving motor 2 through the driving control board 112, so that the present disclosure can operate independently with power supply.

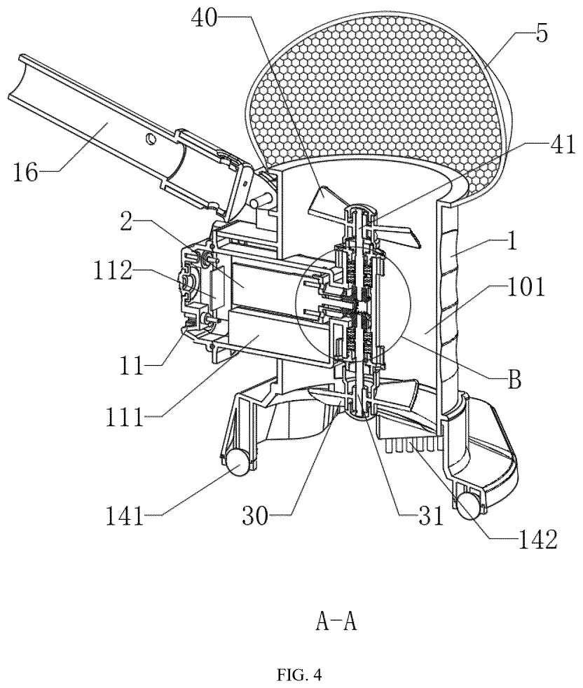

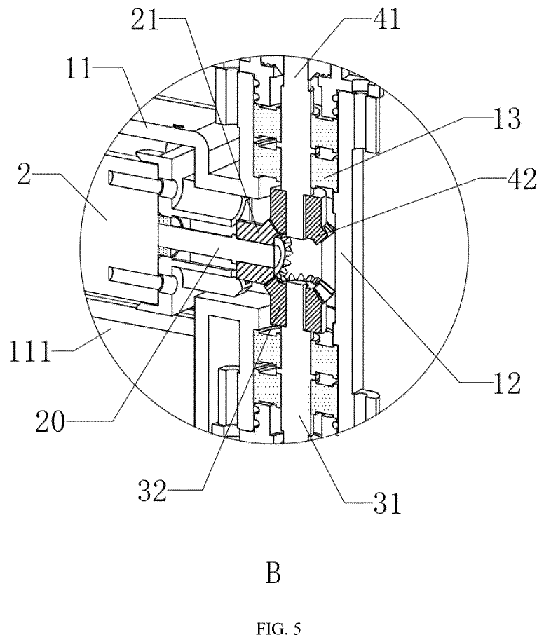

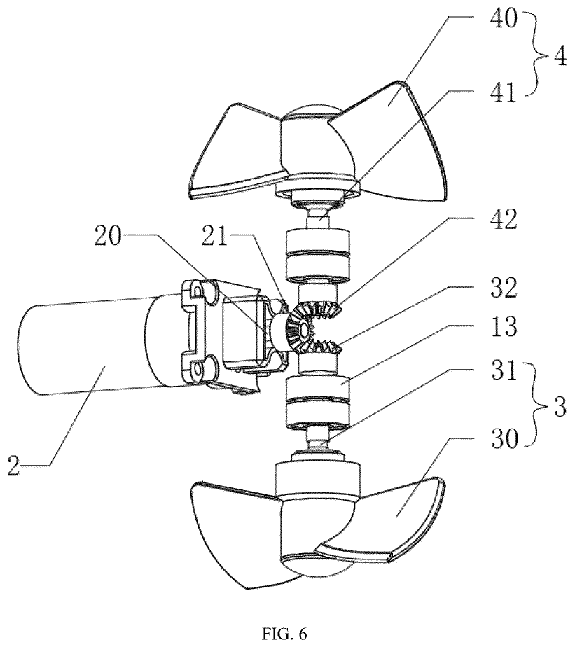

As shown in FIGS. 4-6, in this embodiment, the transmission structure includes a driving bevel gear 21, a first driven bevel gear 32 and a second driven bevel gear 42. The driving bevel gear 21 is coaxially fixed on the output shaft 20 of the driving device, the first driven bevel gear 32 is coaxially fixed on the lower impeller component 3, and the second driven bevel gear 42 is coaxially fixed on the upper impeller component 4. The two sides of the driving bevel gear 21 are respectively meshed with the first driven bevel gear 32 and the second driven bevel gear 42, and the blades of the lower impeller component 3 and the upper impeller component 4 are arranged in opposite directions. The driving device drives the driving bevel gear 21 to rotate, and the upper impeller component 4 and the lower impeller component 3 are driven to rotate reversely by the meshing transmission of the driving bevel gear 21 with the first driven bevel gear 32 and the second driven bevel gear 42. At the same time, because the blades of the upper impeller component 4 and the lower impeller component 3 are arranged in opposite directions, the driving directions of the upper impeller component 4 and the lower impeller component 3 to the water flow are always consistent, so that two sets of blades can be driven to rotate at the same time by one driving device, and the first impeller component and the second impeller component cooperate with each other to generate greater suction to the water flow, reduce the influence of turbulent flow and form a stable axial flow, so that the present disclosure can absorb heavier leaves and other pollutants under the same power consumption.

In other embodiments (not shown), the transmission structure can also be belt transmission. The driving wheel is connected with the driving device, and a driven wheel is respectively installed on the upper impeller component 4 and the lower impeller component 3, and both driven wheels are connected with the driving wheel through a belt. Therefore, when the driving wheel is driven by the driving device to rotate, the driving wheel synchronously drives the driven wheels of the upper impeller component 4 and the lower impeller component 3 to rotate through the belt, so that the upper impeller component 4 and the lower impeller component 3 also rotate. Moreover, in this embodiment, the blades on the upper impeller component 4 and the lower impeller component 3 are arranged in the same direction, so that the water flow direction is consistent and a stable axial flow is formed.

Of course, the transmission structure of the present disclosure is not limited to the above two ways, and it can also adopt mechanical transmission forms such as worm gear transmission and friction transmission.

In this embodiment, the lower impeller component 3 includes a first blade 30 and a first connecting rod 31, and the upper impeller component 4 includes a second blade 40 and a second connecting rod 41. The first connecting rod 31 and the second connecting rod 41 are coaxially arranged in the flow channel 101, and the first blade 30 and the second blade 40 are arranged in parallel. By using the spatial layout mode that the upper impeller component 4 and the lower impeller component 3 are coaxially aligned in the vertical direction, the generation of turbulence is further reduced, and the working efficiency of the present disclosure is improved.

As shown in FIG. 3-5, in this embodiment, the machine body 1 includes a chassis 14 near the water inlet end of the flow channel 101, and the bottom of the chassis 14 is provided with four rollers 141, so that the present disclosure can reduce the friction with the ground by using the rollers 141 at the bottom of the chassis 14 and improve the smoothness of the present disclosure moving in water.

The chassis 14 is symmetrically provided with cleaning brushes 142 on both sides of the water inlet end of the flow channel 101. When the present disclosure moves under the water, the stubborn dirt on the water bottom can be brushed off by the cleaning brushes 142, and then the brushed dirt is absorbed into the flow channel 101 and filtered by the garbage collection device 5 for collection.

In this embodiment, there are two cleaning brushes 142, and the two cleaning brushes 142 are distributed on both sides of the water inlet end of the flow channel 101 in a V shape, and the cleaning brushes 142 distributed on both sides in the V shape can play a guiding role, so that the dirt brushed by the cleaning brushes 142 can be better guided into the flow channel 101.

Of course, the arrangement of the cleaning brush 142 is not limited to the V-shaped arrangement described above, and in other embodiments (not shown), it can also be arc-shaped, trapezoid-shaped and the like to facilitate the diversion of garbage and dirt.

The side wall of the machine body 1 is provided with a hinge part 15, and the hinge part 15 is hinged with a connecting handle 16, which is used for connecting the present disclosure with an underwater mobile device for installation more conveniently. At the same time, the hinged connecting handle 16 is allowed to e rotate slightly relative to the underwater mobile device when the underwater mobile device moves in the water, so that the bottom of the present disclosure can be better attached to the water bottom, and the cleaning effect of the underwater mobile device is improved.

The working principle of this embodiment is as follows:

According to the present disclosure, a driving device is installed on the side of the machine body 1, and a lower impeller component 3 and an upper impeller component 4 are arranged in the flow channel 101 of the machine body 1. A first driven bevel gear 32 is coaxially arranged on the first connecting rod 31 of the lower impeller component 3, and a second driven bevel gear 42 is coaxially arranged on the second connecting rod 41 of the upper impeller component 4. When the driving device drives the driving bevel gear 21 on its output shaft 20 to rotate, the upper impeller component 4 and the lower impeller component 3 are driven to rotate reversely by the meshing transmission of the driving bevel gear 21 with the first driven bevel gear 32 and the second driven bevel gear 42. Because the blades of the upper impeller component 4 and the lower impeller component 3 are arranged in opposite directions, the driving directions of the upper impeller component 4 and the lower impeller component 3 to the water flow are always consistent. A driving motor 2 is used to drive the upper impeller component 4 and the lower impeller component 3 to rotate at the same time, and the first impeller component and the second impeller component cooperate with each other to generate greater suction force to the water flow, so that the water flow and dirt can be smoothly sucked into the flow channel 101 and then enter the garbage collection device 5. Then, the garbage collection device 5 is used to filter and collect dirt such as leaves, and the filtered clean water flow is directly discharged through the garbage collection device 5, which plays an effective role in cleaning up water garbage.

In addition, in the present disclosure, the lower impeller component 3 and the upper impeller component 4 are arranged to work together to realize the water absorption of the flow channel 101, so that the water flow pumped up by the lower impeller component 3 will give an impact force to the upper impeller component 4 located above, and the rotation of the upper impeller component 4 is more labor-saving. Furthermore, the rotation of the lower impeller component 3 will generate vortex above it to form turbulence, and the upper impeller component 4 will quickly pump the water above the lower impeller component 3 into the garbage collection device 5, thus avoiding the vortex generation between the lower impeller component 3 and the upper impeller component 4, further reducing the turbulence influence caused by the vortex, making the operation of the present disclosure more stable, and having the effects of high transmission efficiency, reduced power consumption and more stable operation.

The present disclosure is not limited to cleaning swimming pools, but also can be applied to cleaning landscape pools, fish ponds, hot springs and other places.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A double-impeller leaf collector, comprising a machine body, wherein the machine body is provided with a flow channel and a water absorption mechanism, wherein
the flow channel is at least provided with a water inlet end and a water outlet end, and the water outlet end is provided with a garbage collection device; and
the water absorption mechanism comprises a driving device, and a lower impeller component and an upper impeller component arranged in the flow channel; and
wherein the driving device is connected with the lower impeller component and the upper impeller component through a transmission structure; and
wherein the driving device drives the lower impeller component and the upper impeller component to rotate through the transmission structure, and drives the water to be sucked into the flow channel and then enter the garbage collection device for filtering.

2. The double-impeller leaf collector according to claim 1, wherein the transmission structure comprises a driving bevel gear, a first driven bevel gear and a second driven bevel gear; the driving bevel gear is coaxially fixed on an output shaft of the driving device, the first driven bevel gear is coaxially fixed on the lower impeller component, and the second driven bevel gear is coaxially fixed on the upper impeller component; the two side of the driving bevel gear are respectively correspondingly meshed with the first driven bevel gear and the second driven bevel gear, and the blades of the lower impeller assembly and the upper impeller assembly are arranged in opposite directions.

3. The double-impeller leaf collector according to claim 1, wherein the lower impeller component comprises a first blade and a first connecting rod, and the upper impeller component comprises a second blade and a second connecting rod, wherein the first connecting rod and the second connecting rod are coaxially arranged in the flow channel, and the first blade and the second blade are arranged in parallel.

4. The double-impeller leaf collector according to claim 1, wherein the driving device comprises a shell and a driving motor sealed in the shell; the shell is fixedly connected to a side wall of the machine body, the shell is fixedly connected with a protective casing, and the transmission structure is hermetically arranged in the protective casing.

5. The double-impeller leaf collector according to claim 4, wherein the lower impeller component comprises a first connecting rod, and the upper impeller component comprises a second connecting rod; bearings are correspondingly arranged between the first connecting rod and the protective casing, between the second connecting rod and the protective casing, and between the output shaft of the driving motor and the shell.

6. The double-impeller leaf collector according to claim 4, wherein a power supply module and a drive control board are arranged in the shell, and the power supply module is electrically connected with the driving motor through the drive control board.

7. The double-impeller leaf collector according to claim 1, wherein the machine body comprises a chassis near the water inlet end of the flow channel, and a plurality of rollers are arranged at the bottom of the chassis.

8. The double-impeller leaf collector according to claim 7, wherein the chassis is symmetrically provided with cleaning brushes on both sides of the water inlet end of the flow channel.

9. The double-impeller leaf collector according to claim 8, wherein there are two cleaning brushes, and the two cleaning brushes are distributed on both sides of the water inlet end of the flow channel in a V shape.

10. The double-impeller leaf collector according to claim 1, wherein the side wall of the machine body is provided with a hinge part, and the hinge part is hinged with a connecting handle.

11. A double-impeller leaf collector, comprising a machine body, wherein the machine body is provided with a flow channel and a water absorption mechanism, wherein
the flow channel at least has a water inlet end and a water outlet end, and the water absorption mechanism comprises a driving device and an impeller component installed in the flow channel; and
wherein at least two groups of impeller components are arranged and close to the water inlet end and the water outlet end respectively, and the at least two groups of impeller components push water in the flow channel to form an axial flow; and
the driving device is accommodated in the machine body, and a transmission structure is arranged between the driving device and the impeller components.

12. The double-impeller leaf collector according to claim 11, wherein the impeller components comprise a lower impeller component and an upper impeller component, which are respectively installed at the water inlet end and the water outlet end of the flow channel, and the water outlet end is provided with a garbage collection device.

13. The double-impeller leaf collector according to claim 12, wherein an outer wall of the machine body is provided with a shell for accommodating the driving device, and the driving device comprises a driving motor installed in the shell, and a power output end of the driving motor is provided with an output shaft.

14. The double-impeller leaf collector according to claim 13, wherein the transmission structure comprises a driving bevel gear, a first driven bevel gear and a second driven bevel gear located in the shell; and
wherein the driving bevel gear is connected with the output shaft, and the first driven bevel gear and the second driven bevel gear are respectively meshed at two opposite ends of the driving bevel gear.

15. The double-impeller leaf collector according to claim 14, wherein the lower impeller component comprises a first connecting rod and a first blade installed at one end of the first connecting rod; and
the upper impeller component comprises a second connecting rod and a second blade installed at one end of the second connecting rod.

16. The double-impeller leaf collector according to claim 15, wherein the first blade is arranged opposite to the second blade, and the other ends of the first connecting rod and the second connecting rod both penetrate into the shell and are rotatably connected with the shell; and
wherein the first driven bevel gear and the second driven bevel gear are respectively connected with the first connecting rod and the second connecting rod.

17. A double-impeller leaf collector, comprising a machine body, wherein the machine body is provided with a flow channel and a water absorption mechanism, wherein
the flow channel at least has a water inlet end and a water outlet end, and the water absorption mechanism comprises a driving device, and a lower impeller component and an upper impeller component installed in the flow channel; and
wherein the lower impeller component and the upper impeller component are respectively close to the water inlet end and the water outlet end, and the lower impeller component and the upper impeller component are used for pushing water in the flow channel to form an axial flow; and
the driving device is accommodated in the machine body, and a bevel gear transmission mechanism is arranged between the driving device and the lower impeller component and the upper impeller component.

18. The double-impeller leaf collector according to claim 17, wherein an outer wall of the machine body is provided with a shell for accommodating a driving device, and the driving device comprises a driving motor installed in the shell.

19. The double-impeller leaf collector according to claim 18, wherein the bevel gear transmission mechanism comprises a driving bevel gear, a first driven bevel gear and a second driven bevel gear located in the shell; and
wherein the driving bevel gear is connected with a power output end of the driving motor, and the first driven bevel gear and the second driven bevel gear are respectively meshed at two opposite ends of the driving bevel gear.

20. The double-impeller leaf collector according to claim 19, wherein the first driven bevel gear and the second driven bevel gear are respectively installed on the lower impeller component and the upper impeller component.
